(19) United States
(12) Patent Application Publication
(10) Pub. No.: US 2020/0235954 A1
(43) Pub. Date: Jul. 23, 2020

(54) Methods and Systems for Allowing the Generation of Multi-Author Communications

(71) Applicant: Jon Frank Shaffer, Main Beach (AU)

(72) Inventor: Jon Frank Shaffer, Main Beach (AU)

(21) Appl. No.: 16/745,314

(22) Filed: Jan. 16, 2020

Related U.S. Application Data
(60) Provisional application No. 62/793,900, filed on Jan. 18, 2019.

(51) Int. Cl. H04L 12/18; G06Q 10/06; H04N 21/462; H04N 21/80; G06Q 50/00; H04W 64/00; H04L 29/06; H04W 4/021

(52) U.S. Cl. CPC H04L 12/1822; G06Q 10/06; H04N 21/462; H04W 4/021; G06Q 50/01; H04W 64/003; H04L 67/38; H04N 21/80

(57) ABSTRACT

A method for producing or distributing a multi-author digital communication which includes a creator providing at least one item of digital content; forwarding a communication referencing that item of digital content to a selected group of recipients; and each recipient adding, at their option, additional digital content. A server automatically forms a composite work including at least the digital content, additional digital content and further material specific to each recipient which is selected from that recipient's stored material.

### TECHNICAL FIELD

The present invention relates to methods and systems for allowing the generation of multi- author communications and composite works.

### BACKGROUND OF THE INVENTION

Social media and messaging are widely known and used in many forms in modern culture. The widespread use of smartphone, tablets, PCs, and wearable devices has created a world in which images, videos, audio and text are widely shared and transmitted, to wide audiences (for example via twitter) or to selective audiences (for example via Linked In, Facebook or Instagram).

Messaging platforms, for example Snapchat, WeChat, Line and the like, are also in widespread use. Business messaging systems, in game systems and other such system operate in broadly similar ways. A common characteristic of these platforms is that one person is the creator or author. While there may be, for example, a thread of messages, each part is contributed separately, in a conversational type mode. Material may be widely shared, but the origin is a single party.

It is an object of the present invention to provide a method and system to permit messaging, social media and other systems to facilitate and distribute multi-author messages, communications and composite works.

### SUMMARY OF THE INVENTION

According to a broad aspect, the present invention discloses a technical arrangement in a messaging system allowing utilization of sharing capabilities for the generation of multi-author communications and composite works.

According to one aspect, the present invention provides a method for permitting group participation in cheering at a shared event using portable devices, wherein each member of the group is provided with a device, the group is invited to cheer or otherwise support a participant in the event, each member's activity is monitored, and on that basis an indication of the support is determined.

According to another aspect, the present invention provides A method for producing/distributing a multi-author digital communication, including at least the steps of: a creator providing at least one item of digital content; Forwarding a communication referencing that item of digital content to a selected group of recipients; Each recipient adding, at their option, additional digital content; Wherein a server automatically forms a composite work including at least the digital content, additional digital content and further material specific to each recipient, selected from that recipient's stored material.

According to a further aspect, the present invention provides A method for providing a personalized digital work for a user, including at least the steps of:
a provider inviting a user to create a personalized work; a user indicating agreement, by shaking their device, or otherwise indicating agreement using their device;
the user sending digital material, or links to such material, automatically;
the provider generating a composite work, using the digital material, further digital material or links automatically selected by the provider, and a framework for adding the further digital material to the digital material, so as to construct a digital work; and; Providing a link to the work to the user.

According to another aspect, the present invention provides a method for providing an electronic game, wherein during operation of the game, digital content is accessed from within a user's device, and used to provide part or the images or other functions within a game.

That is, disclosed are methods and systems for producing/distributing a multi-author communication, including at least the steps of a creator device forming a multi-author communications group with a plurality of recipient devices, the creator device receiving an instruction to select from available digital content to configure the digital content as output to the multi-author communications group, one or more recipient devices receiving instructions to select from available digital content and configure digital content as output to the multi-author communications group, a server automatically forming a composite work of the digital content, the server generating composite work that interacts with the multi-author communication group wherein individual devices of the multi-author communications group configures additional digital content for addition to the composite work specific to each individual device.

### BRIEF DESCRIPTION OF THE DRAWINGS

Illustrative implementations of the present invention will now be described with reference to the accompanying figures, in which:

FIG. 1 provides an overview of an arrangement which is contemplated;

FIG. 2 shows a method for providing an electronic document (such as a fabzing) to a user according to a first embodiment;

FIG. 3 depicts methods and systems for GroupZing;

FIG. 4 illustrates method and systems for shakeZing;

FIG. 5 illustrates methods and systems for gameZing; and

FIGS. 6-16 are screen shots of example components of various works created according to implementations of the present invention; and

FIG. 17 is a diagram illustrating the Phone Cheering implementation.

### DETAILED DESCRIPTION OF THE INVENTION

The present invention will be described with reference to specific examples and implementations. However, it will be appreciated that the present invention is of broad scope and can be applied to any suitable system.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

A first implementation of the present invention has a front end which is an app for a smartphone or tablet, and a back end which is an internet based server, database and associated presentation, communications and searching software. Of course, it will be understood that the invention could be implemented using alternative means, for example as a web app, or as a standalone software product for home PCs and the like. However, the smartphone/tablet app implementation is preferred, as the image and video capture capabilities of such devices are a convenient way of capturing content for the purposes of the present invention, and this approach facilitates rapid and easy adoption by patrons.

Smartphones and tablets generally have access to communication networks such as the Internet via 3G or 4G communication systems, and/or Wi-Fi where content can be sourced. It is also disclosed that one or more of these communication devices can by-pass a commercial/entity communications network, processing content between them, for example via Wi-Fi. One or more mobile communication devices can act as a server to one or more other such devices. That is, a private or peer-to-peer communication device network can be utilised.

It will be appreciated that the app is downloaded and/or made operative subject to terms and conditions of use, so as to govern issues of privacy, data collection, copyright in images and text, and other related issues.

The term ‘network’ is intended in its broadest sense. It includes public and private networks, illustratively those applying TCP/IP protocols such as the internet, but not limited to such networks. They may be cellular networks, local area networks (LANs), wide area networks (WANs), peer to peer networks, or any other suitable network architecture. The physical implementation of such networks may be fixed, wireless, near field, Bluetooth, optical, satellite, mobile or any other suitable form.

The present invention is envisaged as having implementations which are within or associated with or facilitated by existing software products, for example messaging or social media. As such, the full details of such an overall system will not be described in detail, as they are already familiar to and well understood by those skilled in the art.

The present invention may be conveniently implemented using a server based virtual facility, such as the facility operated by the applicant as FabZing. Details of the implementation of this system are provided in the applicant's patent application Nos. WO 20112041827 (U.S. No. 61/272,545) and U.S. provisional application No. 61/746,774 by J Frank Shaffer. Related implementations are disclosed in PCT/IB2014/060243 and PCT/AU2015/050559. These disclosures are hereby incorporated by reference. A suitable implementation of a server based, user controlled multimedia messaging system is the FabZing system, which is available at www.fabzing.com and is commercially operated by the present assignee. Of course, any other suitable system may be used to implement the invention.

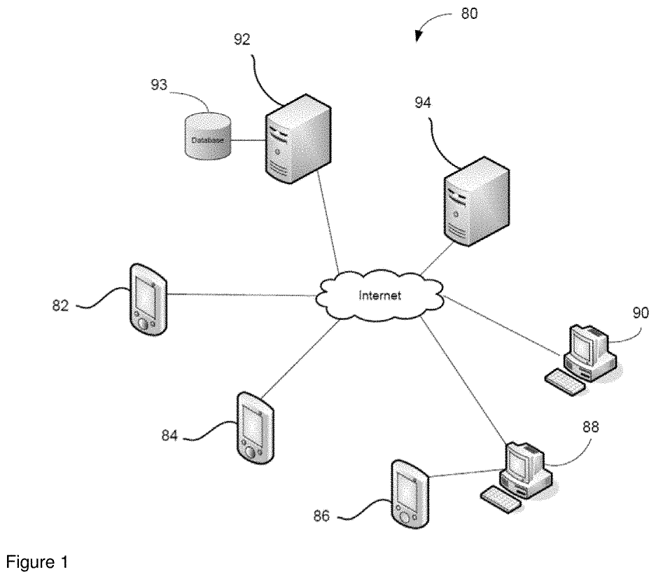

FIG. 1 provides an overview of an arrangement which is contemplated. There may be a group of devices which contribute to the content of the formed group. The group of devices shares the content between the group of devices. The communication device can have stored content or can access content via its connection to the Internet or other networks, using telecommunication systems such as Wi-Fi or 4G systems, wired or wireless. Server 92 provides the functional processing, including connection to stored information, account details, and the like required for the system to operate. As mentioned above, it is contemplated that the server 92 may be a mobile communication device. The network 80 includes one or more client processing systems and one or more server processing systems. In this example, the client processing systems include smartphone devices 82, 84, 86 and personal computers (PCs) 88, 90. The server processing systems include network servers 92 and 94. The client and server processing systems 82, 84, 88, 90 and 94 are connected via the internet 96 and the smartphone 86 is connected to the PC 88.

The transfer of information and/or data over the network can be achieved using wired communications means or wireless communications means. The server processing systems 92 and 94 can facilitate the transfer of data between the network and one or more databases, such as database 93. It will be appreciated that embodiments of the invention may be realized over different networks, such as a MAN (metropolitan area network), WAN (wide area network) or LAN (local area network). Also, embodiments need not take place over a network, and the method steps could occur entirely on a client or server processing system.

It will be understood that the server used according to the disclosed methods and systems may be of conventional type. It may be a real server, or a virtual server distributed over several actual machines. The user interface via the network can be using any device capable on the selected network, and which is able to read the code used according to the implementation of the invention. In the case of an image or video input, this could be a conventional smartphone (e.g. iOS or Android based) with a camera, a compatible app, and internet access via a cellular network or wireless network such as Wi-Fi. Those skilled in the art will appreciate that such devices are widely available, and so the network and user hardware aspects will not be further described.

Functionally, the applicant's service (which may conveniently be based on the internet, or ‘in the cloud’) allows a user to create rich media content combining audio, text, graphics, images and video. The electronic documents created using the applicant's software, known as FABZings, incorporate multiple components to enable the provision of rich, personalized, user defined content.

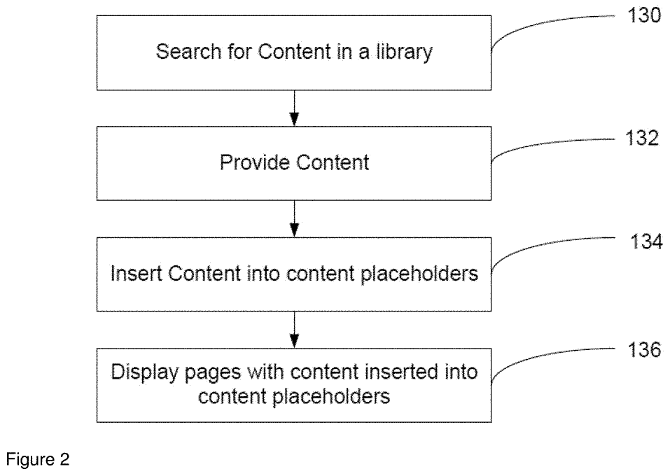

FIG. 2 shows a method for providing an electronic document (such as a fabzing) to a user according to a first embodiment. This may be provided using a convenient web interface, for example from a smartphone. At step 130, instructions enable the user to search for content in a library of content. Instructions provide content for insertion into the electronic document at step 132, for example by downloading content and storing it in the memory of the smartphone 82. At step 134, content can be inserted into one or more content placeholders in response to a request by the user. For example, the user may use a touch screen (or other input device 108) to select content to be inserted. One or more pages of the electronic document can be then displayed on the display screen of the reader at step 136 with the content inserted in the one or more content placeholders. The document, is then able to be stored on the remote server which is providing the media content.

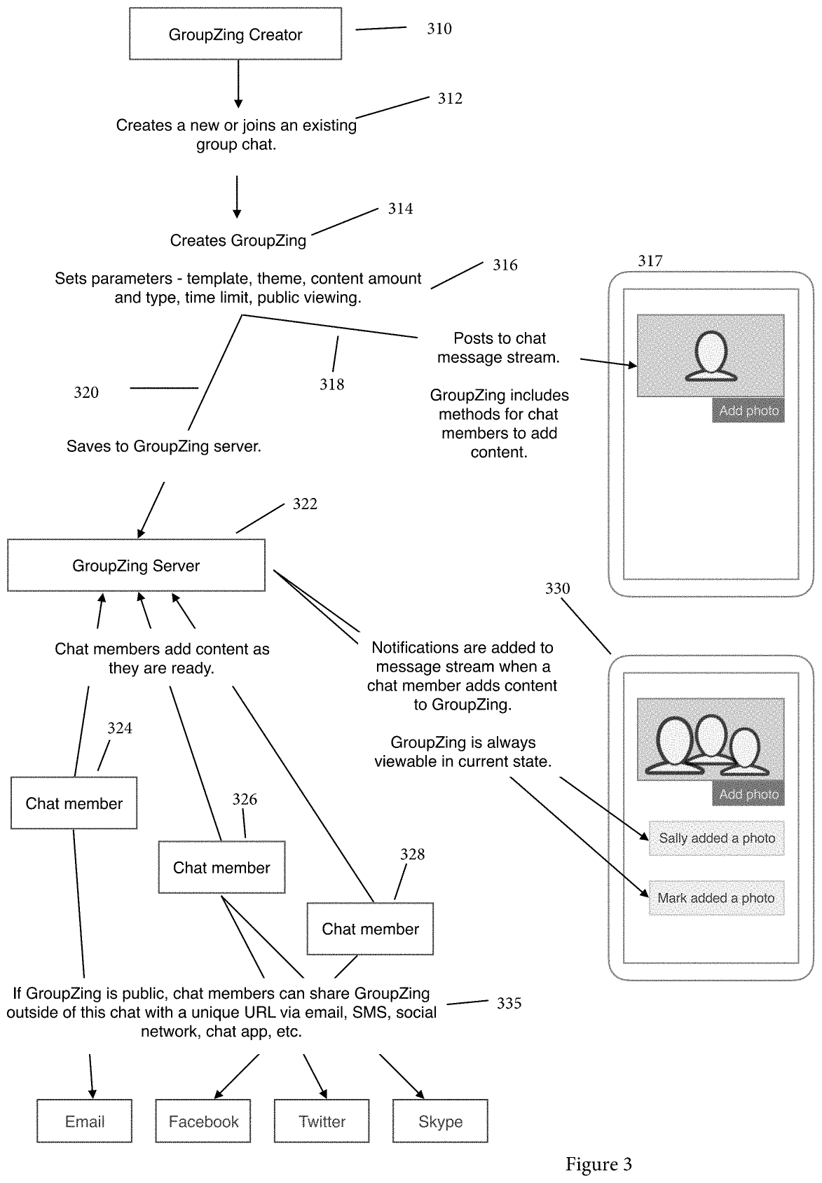

FIG. 3 depicts an implementation of an aspect of the present invention, in which multiple parties contribute to a multi-author communication and composite work, using their smartphones and a messaging app. This will be described as GroupZing. It will be appreciated that the principles of such as system as will described below may be implemented in various systems and using various hardware, but this arrangement is described for illustration of the concepts associated with this implementation.

The GroupZing may be formed over a network as described above, or between devices where one or more devices act as a server. By way of general overview, implementations of the disclosed systems and methods allow for a group of devices to be defined, for example by a creator using a device. A message is sent by the creator's device which provides an invitation to another device. Protocols to establish an invitation and acceptance can depend upon the communication network established and utilized. In the event that the network is private or peer-to-peer, that is, where communication is directly between devices as described above, security protocols can be heightened.

A GroupZing can result in a group of users contributing content via their devices, where the composite output at each of a plurality of devices may be different from the output at other devices in the group, but may also be the same. The shared content output at a device of the group can be determined by the device, itself, or it can be determined remotely. Depending upon output configurations, the shared content can be formatted for specific platforms, individually formatted for output to a device, formatted for viewing on a display of larger dimensions than a device, such as smart TV, computer screen, or even a display screen of a stadium wherein sound and other sensory products such as smell can be provided. It is understood that the output format can be established when the output device is determined. It is also understood that the particular content displayed can be determined depending upon the output format.

A sender device, in this disclosure referred to as a GroupZing Creator device 310, can establish a group of devices 312. More than one device can be a sender device. The group of devices may be selected from a contact list, for example that resides on the GroupZing Creator device 310. A group of devices may be pre-determined, established in real-time, or may be provided to the device from a remote device. For example, a group of devices may be collated by a remote server, or a group may already have been set up by the user and then selected. Depending upon the implementation, identifying details, such as telephone numbers, or IP addresses, may be coordinated by a service or other entity. Access to such device details collated remotely may conveniently be by creating a new or joining an existing group chat 312.

A GroupZing is established 314, by selection of this by the creator within the group chat defined at 312. Parameters are determined previously, simultaneously, or subsequently 316, for example template, theme content amount and type, time limits, public/private viewing permissions, and so forth. These are broadly similar to parameters for social media or chat applications. FabZing placeholders may be established. Furthermore, one or more filters for determining of whether the content file is relevant, appropriate and/or timely, or any other suitable criteria for the contributions from various members of the group to be contributed to the GroupZing, can be established. It is understood that any types of parameters can be established, while instructions for carrying them out can be executed by an app stored on the device, on the creator's device, or may be executed remotely.

In a configured GroupZing, each user, via their device, is enabled to contribute one or more image or other available content. Available digital content can include but is not limited to images, video and/or sound files on the device, files in the cloud, files retrieved from the Internet, and files on social media. This content can be dynamically updated in real time to create personalized videos or other form of content mashup, which can update as new content is added. In preferred forms, each device in the group can receive different output such as a different video, as it incorporates material specific to each device, for example additional images, music or gifs from its own library. The content may be an actual file, or a URL or other locator.

In such an implementation, a remote server may be used to deliver the different output to each user's device. The output may be customized for one or more particular users. However, also at the device and devices in communication, the content of the output may be altered so that it is customized for a user. The output of the multi-author communications and composite works therefore may occur at any given location, at a server or at a device.

Implementations of the disclosed systems and method provide a new way to create a dynamic video that is sourced from numerous contributors in real time. Rather than relying on a singular video file format, implementations of the present invention allow for streaming of numerous media types (for example gifs, images, text, video, sound) as part of a unifying cloud based creation that dynamically updates in real time as new content is added. This creation will be referred to in this implementation as a GroupZing.

An important aspect of the present implementation is that the server creates a composite FabZing file for each GroupZing, but this is not, for example, a rendered video file. It is a series of curated connections to URLs, including to the server but also to other internet resources as required. Thus, a composite work, and more particularly a group of composite works associated with the GroupZing, may be created very quickly and sent without large resources, bandwidth or processing power being required.

Arrow 318 a creator's device 317 sending out an invitation to recipient users, the members of the group chat from step 312, via their devices, asking for contributions to a GroupZing (GZ). For example, the creator via their device 317 may provide instructions to identify a theme, for example, “how is your day going?”.

Message 320 in parallel is sent to GroupZing server 322, which will receive the various items of content and generate the GZ. Chat members 324, 326 and 328 can transmit content files to the server 322, in order to contribute to the GZ initiated by creator 310. A device 330 is associated with one of the chat members. The screen shows that a composite work has been created, using images also from chat group members Sally and Mark, as well as from the creator 310. It will accordingly be understood that the GroupZing has a dynamic phase—while contributions are arriving, the final form and content are not fixed and not predictable. Some or all of group chat members may contribute. This variability and uncertainty adds to the interest of the composite work, and provides a functionality which is not possible within any existing system. It is functionally and technically very different to a simple serial stream of images in, say, a message chain.

As can be seen, server 322 provides notifications which are added to a message stream when a chat member device adds content to GZ. The GZ can be viewable as output in its current state, or parameters set may provide that the GZ is viewable as output at a particular time, and/or for a particular time period. Parameters set 330 may provide that a GZ is output via platforms 335 such as email, Facebook, Twitter and/or Skype.

It will be seen that the GZ dynamically updates in real time as each new content files, such as a photo is added. For example, there could be existing music and gifs in a templated layout that would change in length as each photo is contributed. In another example, five minutes after the invitation message has been sent out only 3 people have responded with images and the subsequent GZ is only 15 seconds in length. With each additional image file the GZ would increase in length by about 5 seconds to where ultimately the GZ has included an image from all 10 recipients thereby creating a final GZ which is nearly 1 minute in length. Parameters may include that the GZ could be locked off from further updates or contributions based on a predetermined time limit but could also just as easily be left open indefinitely.

This dynamic content creation method in real time involving numerous contributors from potentially any location or device lends itself to repeated viewing as it has ‘sharing’ as an essential part of its creation and DNA. Further implementations of GroupZing could involve, for example: parties; food gatherings (lunch or dinner party); weddings (improvised photo album); attendance record in visual format; concerts and sporting events. In a further implementation, a virtual photo raffle could take place. For example, at a sporting event, patrons may be invited to submit a photo from the game. A certain number are selected to be part of the winning GroupZing, which is subsequently played on the scoreboard or other display, and/or distributed to all the participating patrons.

A further aspect of the present invention relates to a method of creating a personalized composite work which is produced by a user shaking their phone or similar mobile device, from their own or remotely curated or accessed content, or a combination thereof. Users could be invited to ‘shake their phone and make their own’ which will be referred to as ShakeZing (SZ). In this case, an administrator of content would automatically (responsive to predefined user or system selected criteria) select and access content, and create a composite work (in a preferred implementation as FabZing) by shaking a device. Of course, any type of instruction to access content in accordance with an app configure to provide output of SZ is within the scope of this discussion. For example, a user accessing an app page of a communication device and clicking an SZ app could access and output content in the described manner.

As an introduction to SZ, the majority of humans are visual animals as evidenced in part by the huge influx of video content currently being viewed on the internet. While there are many advantages of a single linear video format, there are also a significant number of problems as well. File sizes are often quite large, complicated, and consequently expensive while also taking a significant amount of time to render (create) which effectively means that a short 10-30 second video can't be ‘created faster than it can be viewed.’

In contrast, a digital photo which is now created instantly (digitally) and can be shared globally. While photos are created in a fraction of a second, they are typically viewed by a recipient for several seconds making it the first medium in human history to invert the creation to be much smaller than consumption time.' This aspect of the present invention in suitable implementations facilitates a much smaller creation time than viewing time, despite the composite work created being cinematic in nature (which will be further explained below).

According to this implementation, simply by shaking the phone (or any other number of triggers) a 15-90 second personalized music or sports video is created instantly comprised of gifs, a song or music playlist, a sponsor's branding, imagery from a sport or musician along with photos from a user's phone. This hybrid mixture of content could be personalized around any number of factors/settings such as: location, time frames, and topic. A typical implementation might involve a fan shaking his phone before the game in a team's parking lot and creating a personalized ‘tail gate party’ video that includes his photos taken in that part of the stadium along with branding (e.g., BBQ sauce) and premium content from the team. Once the game has started and he is at his seat a different themed personalized sports video could be created by shaking his phone (or perhaps some other hand gesture that is emblematic of the team.) A number of other theme based versions might exist around the stadium based on, for example, a fan's location (e.g., using I-beacons,) preferences, and status.

The available digital content could be accessed in any conventional way, or there may parameters initiated to drive access to content, for example the date of the content creation. The content, including any and all content such as videos, images and music files, can be delivered to an output device such as a display screen. In one embodiment, the content may be delivered via GroupZing. In Group Zing, the content can be pushed to cloud-based app that delivers the content in combined form to the participants.

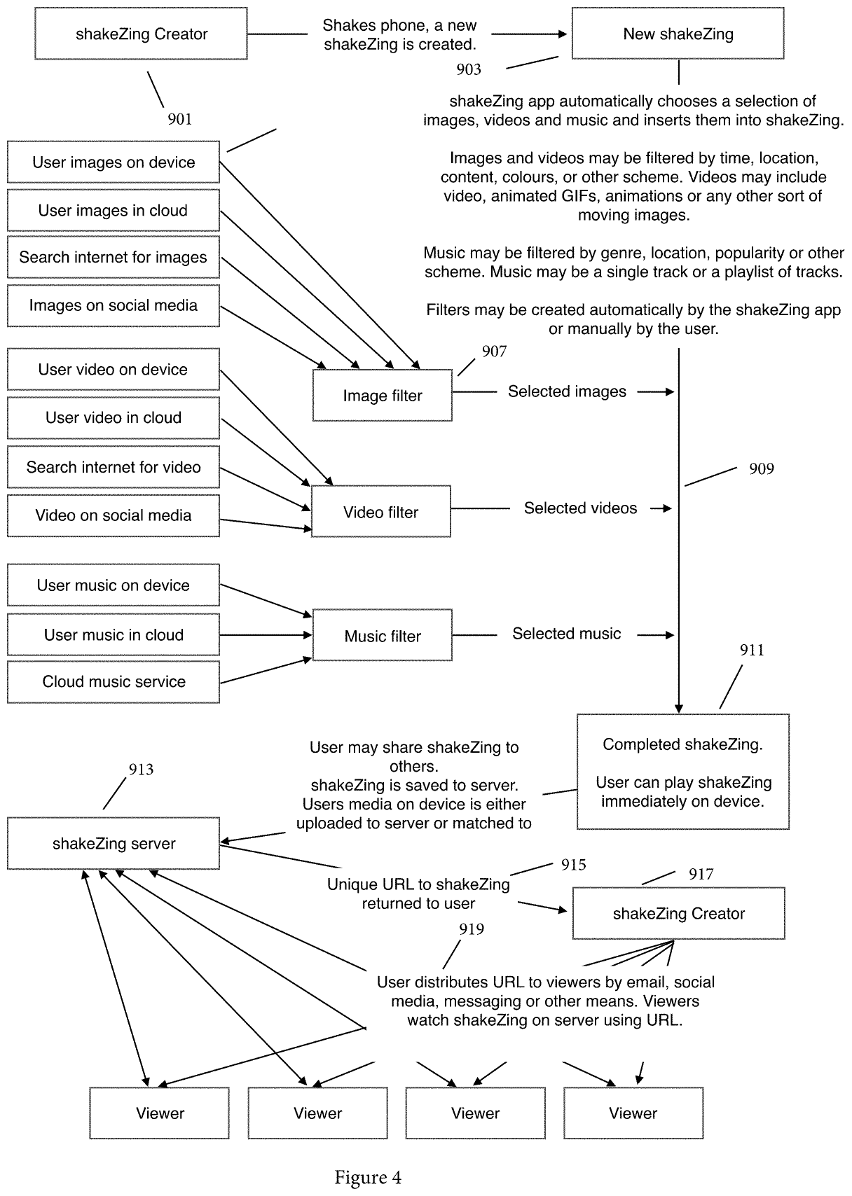

Referring to FIG. 4, a SZ creator device 901, initiates an application to configure new SZ output 903. The SZ application can automatically select and configure available digital content 905. Available digital content can include images, video and/or sound files on the device, files in the cloud, files retrieved from the Internet, and files on social media. As this term indicates, any available digital content is included. Applicable filters 907 can be applied for the selection of files 909.

A further implementation involves the sharing of a whole playlist with this dynamic format of video. Should a recipient wish to listen after the finish of the initial video, the music playlist can continue playing while also offering the option for users to have their own imagery interact with the existing content or formulate whole new videos in real time. This ongoing mixing and creation of multimedia content in real time is especially personalized and unique to each person viewing. It will be appreciated that this provides opportunities for personalization well beyond the existing one dimensional single file format of existing video streams.

The video stream may be completed when for example, the shaking is completed 911. The stream may be shared with others in real time, for example by GroupZing, by sending a URL link, or in any suitable way. The stream may be saved and stored on the device and/or a server 913. In one embodiment, a unique URL may be assigned to the saved file 915, and then delivered to the creator device 917. The stream or the saved file can be delivered to other devices in any suitable manner 919.

It will be appreciated that the composite works created will typically combine images, video, gifs, music, and other audio. As such, it is difficult to illustrate a completed GroupZing, ShakeZing or Game Zing using the limited still graphics and text possible within a patent application. It is important to appreciate that it is the technical functions, applied in a particular way, that allow for such a unique type of work to be created. The examples are merely to show some of the possible outcomes.

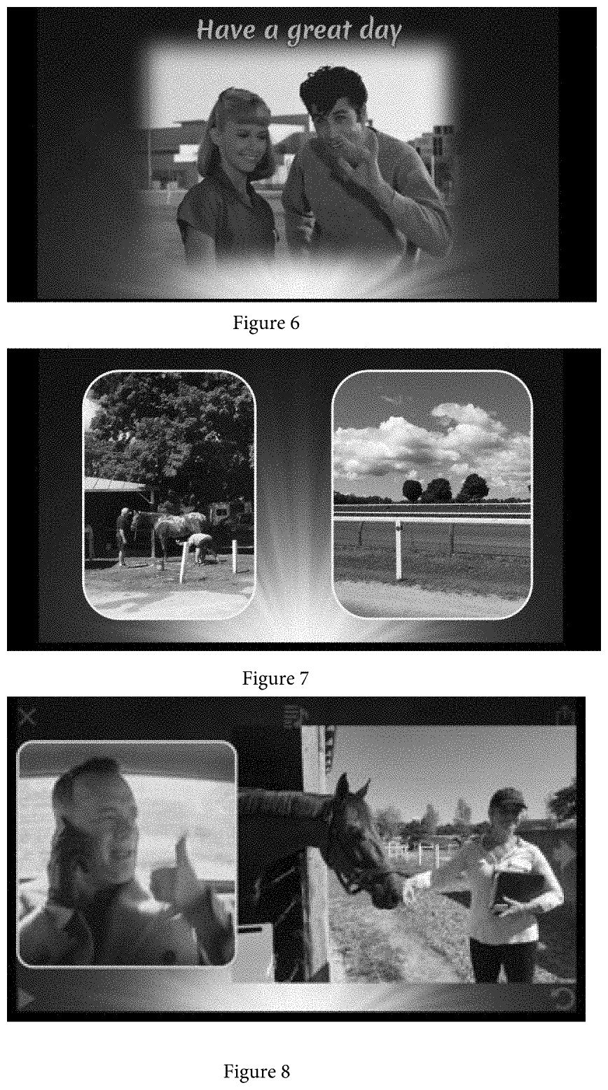

FIG. 6 illustrates a statement ‘have a nice day’ with a gif illustrating that sentiment. FIG. 7 is then two user contributed photos, framed. FIG. 8 is then another photo, this time coupled with a thumbs up gif, again illustrating the idea of ‘have a great day’.

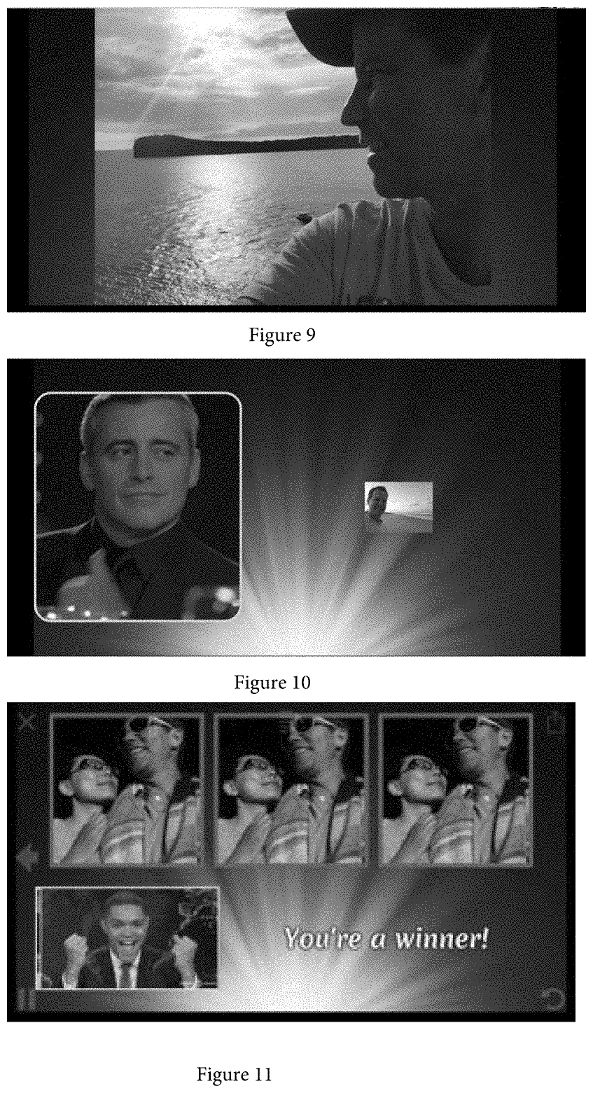

FIG. 9 illustrates sample screens from within a short ShakeZing. This is an image from the recent photos of the user. FIG. 10 illustrates another image from the user on the right, being moved and reduced in size, with a gif on the right. FIG. 11 shows a series of the same photo, with a gif and the text ‘you're a winner’. This latter sequence may be automatically used to indicate that a user had won a game or competition.

It is important to appreciate that the concepts and implementations described may also be implemented in a autonomous or ‘bot’ mode. For example, a messaging system itself could prompt a chat group or broader group of users to contribute to a GroupZing. This could be promotional in character, or purely an additional, fun feature within an application. It could be prompted by an event, for example a ticket purchase, a thank you for a purchase online, a welcome for a new customer, or a wide range of other applications. In this case, the ShakeZing may be the final stage for the user to get their reward, or the operator may autonomously put the composite work together, including for example their stock material and user content such as music and images.

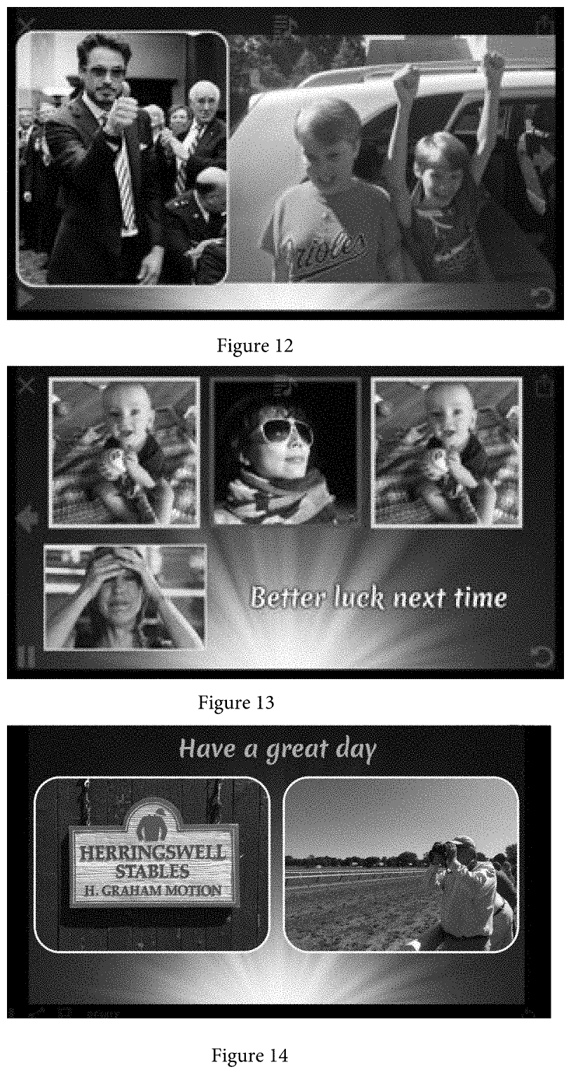

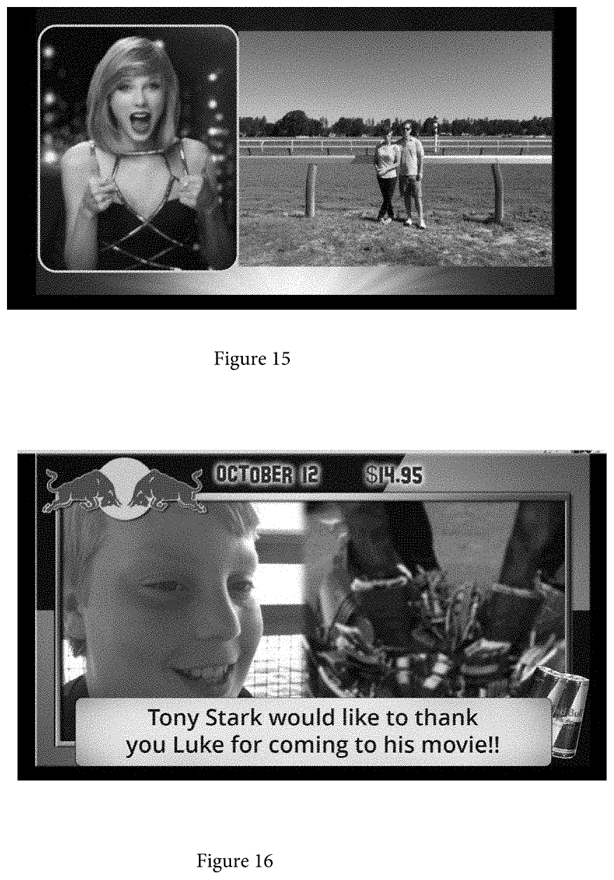

FIG. 12 is another screen shot, combining a .gif and a user image. FIG. 13 is the counterpoint to FIG. 11, in which the user has (e.g.) played a competition, and been unsuccessful. FIG. 14 combines again two user images, with a frame and ‘have a great day’. FIG. 15 is again a gif combined with a user image.

Another implementation of the present invention will be referred to as GameZing. According to this implementation, when an app is accessed on a user's device, digital content may be within the app, relating to the user. This may be, for example, images from the user's own phone or digital storage facility. It may reflect the user's recent music selections.

For example, an implementation could involve a deck of digital playing cards integrating with a filter for facial recognition, whereby the user's selfies on his smart phone would automatically be blended into the ‘face cards.’ For example, a photo of John Doe is mixed with a red crown and jester's clothing to resemble a personalized ‘Jack of Hearts’ for instantaneous use in Solitaire, Blackjack, Poker etc. This dynamic card play would easily lend itself to all of the ‘face cards’ common in such games along with other themes such as landscapes, sports, and even music or audio cues to create multi modal elements/layers beyond the existing one dimensional static representations currently being used.

In another scenario, a ‘Personalized Queen of Diamonds’ that also has a song (or short verse) attached of “Lucy in the Sky With Diamonds” would perhaps trump other queens used by an opposing player. The queen image would be selected from suitable images, automatically identified by a filter, on the user's phone or other stored images.

It will be appreciated that a multi layered game may be thereby generated, with play enhanced by blending user material in with the game. The ability to engage the user by integrating their own material with the game has the potential to dramatically enhance engagement while also offering enhanced branding and marketing opportunities.

It will be understood that this aspect is not, in a simple form, attempting to modify the underlying game mechanics (although this may be possible in specific games designed to take full advantage of this aspect of the present invention). Existing game implementations may be used, for example in relation to the card games noted above. All that needs change in the simplest version is the image on some or all of the cards—the game mechanics could be conventional, but with new images automatically selected or suggested.

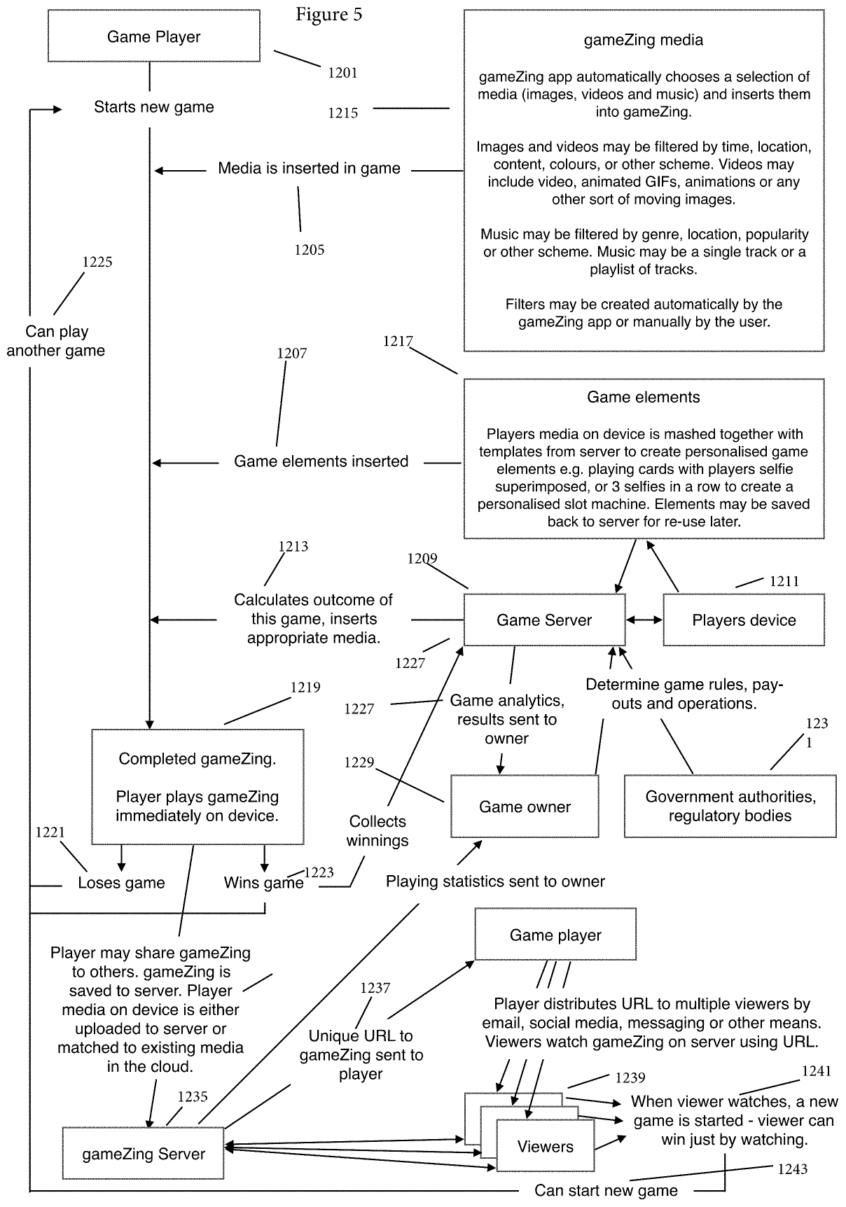

FIG. 5 depicts methods and systems for GameZing where a game player application 1201 can receive instructions to start a new game process 1203. In one embodiment, a game application can be downloaded onto and then accessed on a device. In another embodiment, a game application can be accessed on a dedicated machine where the machine can receive available digital content. Any gaming device or machine is within the scope of this discussion.

A game or other similar process may commence 1203. As digital content output is provided through the process, media can be inserted into the game 1205. Furthermore, game elements can be inserted 1207. In GameZing, (GZ), in one embodiment, the content of the app is not changed, but that the device is adapted to detect how the content of the app is displayed, and then the content of the device is superimposed as the content of the app is displayed. Also, the content of the app and the content of the device can be received by a remote cloud-based server where the content of the app is changed to include the content of the device, and then it is redelivered back to the app, and it is substituted for the content of the app verses superimposed.

It will be appreciated that many of the same approaches and processes which are used to generate a ShakeZing or GroupZing are used, in an appropriate modified way, within the implementation of Game Zing.

A game server 1209 which may be the device itself, coordinates game play with content on the player's device 1211. The game server 1209 may be remote to the device. As the game is played, a process calculates the outcome of the game, which may include a plurality of gaming steps and inserts the appropriate media 1213. The media may be selected and configured according to filters 1215, and the configuration of game elements 1217. A game process may be completed 1219 where the game is lost 1221 or won 1223. Either way, the device can receive instructions to activate a new game 1225. Furthermore, in either case, game analytics 1227 can be provided, including relating to configuration of media as it is inserted into the game. Communication with the server can include that with the game owner 1229 and the government regulatory bodies 1231.

The output of the game can be shared with others 1233. For example a GameZing server can be in communication with a GroupZing server and/or a ShakeZing application. To store results of a game, or any part of the play process output, a unique URL may be assigned 1237 so that the game player, other entity can distribute the URL to other devices 1239. When a device delivers game content to a device, a viewer can win just by watching 1241. A device that receives game content 1239 may start a new game which uses some or all of the content of the previous game, and/or add content as described.

In another implementation, the crowd at an event may be invited to ‘phone cheer now’. In this implementation, a network of phones (or other devices) interact, whereby any number of phone inputs or physical behaviors (e.g., waving or shaking phone, jumping up and down) triggers a sound and light show to be emitted from a user's phone. The sound and light components can be particular to physical locations within a stadium and or remote areas such as bars and living rooms with variations amongst all the different subsets being interdependent based upon anything from participation numbers, rate of change, geography, food consumption, purchasing actions, affiliation by team or product etc. For example, this could be triggered during or after a sporting event, or during a live television event.

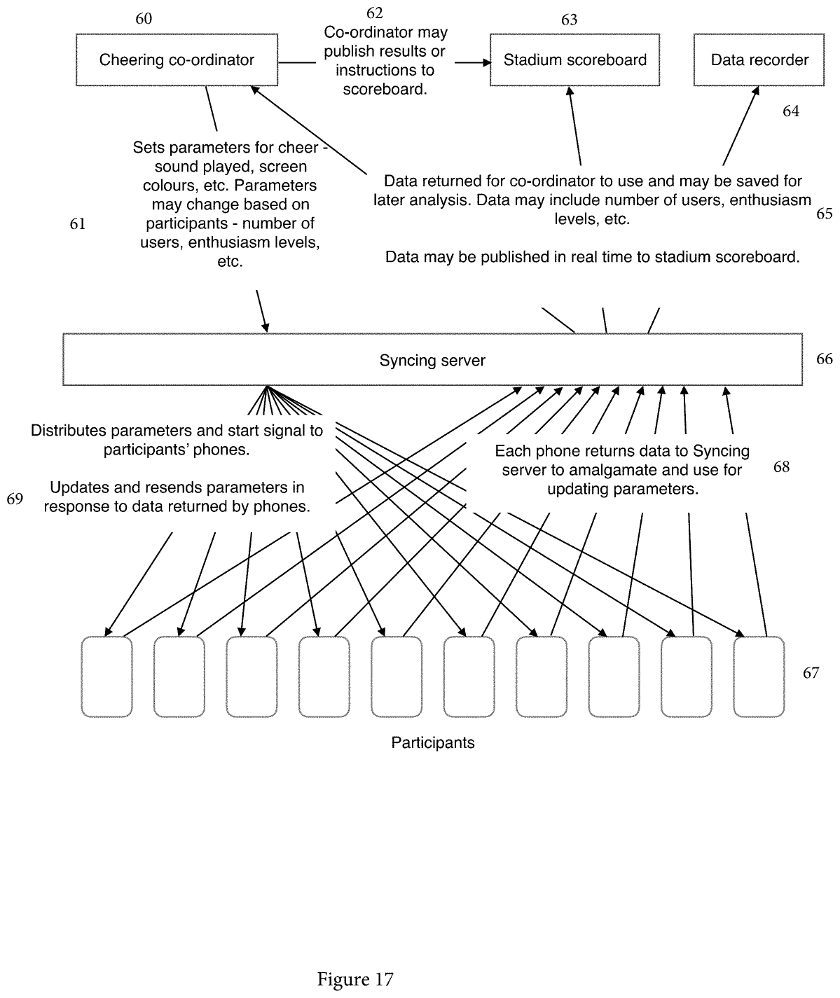

Referring to FIG. 17, this shows one implementation of the phone cheering aspect in overview. Cheering coordinator 60, is preferably a person operating a device in real time, but could be a pre-programmed system, an Al or heuristic system (responsive for example to the state of play, score, innings, etc.). The coordinator at 61 sets parameters for the cheering. This may include the audio played to encourage the cheer, the screen displays, the way the parameters (such as number or enthusiasm) of cheering equates to on screen effects and participant phone effect, and other parameters as desired. It will be appreciated that many of these may be grouped or set in advance, and modified or activated as required. These are sent to the syncing server 66, which will be explained below.

Co-ordinator 60 also sends results, instructions, images, etc. at 62 to the scoreboard 63.

Server 66, at the back end, receives instructions 61 from the coordinator 60, generates data 65 for use in the scoreboard display 63, and returns data to the co-ordinator 60, both for immediate use, and for use in later analysis. Data is also stored in recorder 64 for this purpose. Recorder 64 could be any suitable memory device, and may be incorporated into the coordinator device.

At the front end, each participating member of the audience has an associated device 67. This is typically a tablet or smartphone, or other portable device. In other implementations, a special purpose device could be provided. Each device 67 has a suitable app (or other software feature) loaded in order to participate. The device and app allow on the one hand 69 for parameters, start signals, updates, and ultimately a composite work to be sent to each participant's device 67. On the other hand, they cooperate to send data 68 to the syncing server 66, relating to the use and activity of the device, as well as data (such as data relating to the images etc. on the device) for use in controlling the phone cheer, and in constructing the composite work.

For example, the device and app may send data from a phone's attitude sensors or accelerometer to indicate the shaking level of the device. In other implementations, any level of participation may be enough to trigger an indication that the phone user is cheering, so that proportionality of response is not essential to implementing the invention.

The rate of the sound and light show could change or accelerate as more fans participate giving phone cheering a dynamic component. In one instance a portion of the audience may respond in real time to other sections of the stadium creating a competitive feedback loop that is amplified based on the fans engagement. Further samples include: sections with most participants being highlighted; Speed and color of lights changing; or a breakdown of participating fans from around the globe showing up on the stadium scoreboard (or users phone) in real time.

Each participant's phone uses its sensors to calculate an enthusiasm level. Levels may be calculated by, for example, how quickly participants are shaking their phone, the gesture (circular, chopping, etc.) used for shaking, how the phone is being held. Each phone sends back the level to the Syncing server for processing and will then react to updated parameters, forming a feedback loop.

Examples include:
All phone screens turn red when 10000 participants join cheer.
A new sound is played if participants hold phone over their head.
Sound volume increases as shaking intensity increases.
Participants may be divided into groups for cheering ‘battles’. They could be divided by their seat in the stadium, favored team or player, etc.

The degree of Phone Cheering outside a stadium may be reflected inside the stadium. For example, someone at a stadium who has numerous friends in their network who are also phone cheering (at home, nearby, or in bars etc.) could have that reflected in any number of ways such as their visual or audio outputs increasing (e.g. louder sound or faster color variations, or a premium gold flashing light show).

Fans could also be rewarded with ‘phone cheering’ points, coupons, discounts etc. as a way of encouraging/recognizing loyal fans who continue to cheer for their team even though they are losing by a large margin. It will be appreciated that as a corollary of this feature, a record tracking the level of phone cheering may be readily created, which could then be used to analyze engagement. This could be by comparison to other data, for example music, voiceovers, display and the like intended to encourage participation can be assessed relative to their effect on phone cheering.

Further implementations of Phone Cheering could involve (but are not limited to): watching TV shows; a new form of liking a video or photo; a communal encouragement in an office, or multisite corporate environment; any classroom setting; as a response to speeches (E.g. audience could send green imagery as approval sign without noise—‘silent clapping’ so to speak)

As is evident by the above discussed embodiments, the Group Zing, ShakeZing, GameZing and Phone Cheering have available digital content media configuration and sharing in common. Aspects of each of these methods and systems can be included in the other during their processes. It is understood that these disclosed processes can operate independently, or in partial or full cooperation.

It will be appreciated that the implementations discussed could be triggered in other ways than by the action of a friend or the like. They may be sued to, for example, thank patrons for participating at an event, buying a ticket, making a transaction, or the like. FIG. 16 illustrates a composite work created as a ticket in response to the purchase of a movie ticket, combining (for example) a short video thank you from an actor in the movie in character, with an image of the device owner (or at least from their library) and music either selected by the cinema or movie promoter, or from the collection of the device owner.

1. A method for producing/distributing a multi-author digital communication, including at least the steps of:
a creator providing at least one item of digital content;
forwarding a communication referencing that item of digital content to a selected group of recipients;
each recipient adding, at their option, additional digital content;
wherein a server automatically forms a composite work including at least the digital content, additional digital content and further material specific to each recipient, selected from that recipient's stored material.

2. The method according to claim 1, wherein the creator and recipients are interacting via an app on a mobile device.

3. The method according to claim 1, wherein the digital content is selected from one or more of a social media account, a cloud storage facility, a smartphone or other device associated with the creator or a recipient.

4. The method according to claim 1, wherein the additional digital material is provided by linking.

5. The method according to claim 1, wherein at least some of the additional material is automatically selected.

6. The method according to claim 1, wherein the order of the creator and recipient digital content is automatically controlled.

7. A method for providing a personalized digital work for a user, including at least the steps of:
a provider inviting a user to create a personalized work;
a user indicating agreement, by shaking their device, or otherwise indicating agreement using their device;
the user sending digital material, or links to such material, automatically;
the provider generating a composite work, using the digital material, further digital material or links automatically selected by the provider, and a framework for adding the further digital material to the digital material, so as to construct a digital work; and
providing a link to the work to the user.

8. The method of claim 7, further comprising providing an electronic game, wherein during operation of the game, digital content is accessed from within a user's device, and used to provide part or the images or other functions within a game.

9. The method according to claim 8, wherein images from within the user's phone are selected to be used as images within the game.

10. A method for permitting group participation in cheering at a shared event using portable devices, wherein each member of the group is provided with a device, the group is invited to cheer or otherwise support a participant in the event, each member's activity is monitored, and on that basis an indication of the support is determined.

11. The method according to claim 10, wherein the group are located in the same stadium, theatre or other location.

12. The method according to claim 11, wherein the group are located in different locations but viewing or participating in the same event.

13. The method according to claim 10, wherein the level of activity is related to one or more of the user indicating participation, movement of the device, movement of the deice in a specific way, rate or extent of movement of the device, or another action performed with or using the device.
